(19) United States
(12) Patent Application Publication
(10) Pub. No.: US 2026/0072808 A1
(43) Pub. Date: Mar. 12, 2026

(54) OPTIMIZED FORMAL VERIFICATION-ASSISTED COVERAGE ANALYSIS

(71) Applicant: INTERNATIONAL BUSINESS MACHINES CORPORATION, ARMONK, NY (US)

(72) Inventors: BRADLEY Donald BINGHAM, Austin, TX (US); Jason Raymond Baumgartner, Austin, TX (US); Viresh Paruthi, Austin, TX (US); Shrinidhi Udupi, Holzgerlingen (DE)

(21) Appl. No.: 18/882,488

(22) Filed: Sep. 11, 2024

(51) Int. Cl. G06F 11/36

(52) U.S. Cl. CPC G06F 11/3608

(57) ABSTRACT

Provided are a computer implemented method, computer program product, and system for optimized formal verification-assisted coverage analysis. Priorities are derived for event instances that are subject to formal verification using formal verification results obtained from a current version of the verification model and from formal verification results obtained from a previous version of the verification model.

Formal verification of event instances is performed in an order based on the derived priorities for the event instances. Formal verification is performed for a first set of event instances having a first priority before formal verification is performed for a second set of event instances having a second priority that is lower than the first priority.

### BACKGROUND OF THE INVENTION

### 1. Field of the Invention

The present invention relates to a computer implemented method, computer program product, and system for optimized formal verification-assisted coverage analysis.

### 2. Description of the Related Art

The register transfer level (RTL) behavior of a digital chip is usually described with a hardware description language, such as Verilog or VHDL (VHSIC Hardware Description Language), which describes in detail the operations to execute during clock cycles and the hardware components that execute the operations. Once the logic designers, by simulations and other verification methods, have verified register transfer descriptions, the design may be converted to the hardware implementation.

A process of formal verification is used to determine whether the design implementation satisfies requirements of a specification. Formal verification uses mathematical methods to prove or disprove the correctness of the intended design underlying a system with respect to a certain formal specification or property. Formal verification assists in proving the correctness of systems such as, for example, cryptographic protocols, combinational circuits, digital circuits with internal memory, and software expressed as source code.

Formal verification uses model checking to explore all possible states of a system. The formal verification compiles the hardware model, such as a hardware definition language (HDL) description, into a verification model comprising a mathematical representation of the hardware logic and then proves whether the implementation is valid. The engineer creates assertions comprising statements directing the formal verification tool to determine whether a property or event instance occurs (is “hit”) or does not occur (is “unhittable”) in the verification model. These assertions to disprove or prove are known as event coverages. The formal verification tool analyzes the defined events, also known as assertions or covers, and mathematically determines the inputs, logic and variables that affect the defined event, also known as a cone of influence. Input is randomly driven into the cone of influence for the event/assertion to prove or disapprove the event is occurring in the model representing the hardware design.

### SUMMARY

Provided are a computer implemented method, computer program product, and system for optimized formal verification-assisted coverage analysis. Priorities are derived for event instances that are subject to formal verification using formal verification results obtained from a current version of the verification model and from formal verification results obtained from a previous version of the verification model. Formal verification of event instances is performed in an order based on the derived priorities for the event instances. Formal verification is performed for a first set of event instances having a first priority before formal verification is performed for a second set of event instances having a second priority that is lower than the first priority.

Further provided are a computer implemented method, computer program product, and system for optimized formal verification-assisted coverage analysis providing an event hierarchy tree constructed to associate a relationship between event instances derived from design entities declared in the verification model. An intermediary level of the event hierarchy tree groups at least one node that shares a subunit of logic, and a bottom level of the event hierarchy tree that includes one node for all the event instances. For each node of a plurality of nodes in the event hierarchy tree there is maintained a hit status of an event instance associated with the node determined from formal verification of a current version of the verification model and a prioritization based on the hit status of the event instance associated with the node in one of the current version and a previous version of the verification model. The prioritization of the plurality of nodes in the event hierarchy tree is used to determine an order in which formal verification is performed on the event instances represented by the plurality of nodes in the event hierarchy tree.

### BRIEF DESCRIPTION OF THE DRAWINGS

FIG. 1 illustrates an embodiment of a computing environment to perform formal verification of a verification model.

FIG. 2 illustrates an embodiment of a node for an event instance providing information on a formal verification of the event instance.

FIG. 3 illustrates an embodiment of operations to generate an event hierarchy tree having nodes representing event instances at different levels of hardware logic abstraction to subject to formal verification testing.

FIG. 4 illustrates an example of a model representing the hardware logic and instances of an event to check.

FIG. 5 illustrates an example of an event hierarchy tree generated for the model of FIG. 4.

FIG. 6 illustrates an embodiment of operations to add hints for event instances represented as nodes in the event hierarchy tree based on whether formal verification of the event instance in a previous version of the verification model found the event instance hit or unhittable.

FIGS. 7A and 7B illustrate an embodiment of operations to perform a formal verification of an event instance represented by a node in the event hierarchy tree.

FIG. 8 illustrates an embodiment of operations to use the hints determined for an event instance to determine a priority at which the event instance in a current version of the verification model is subject to formal verification.

FIG. 9 illustrates a computing environment in which the components of FIG. 1 may be implemented.

### DETAILED DESCRIPTION

Model checking tools, such as formal verification, face a problem known as the state explosion problem, which is a combinatorial explosion in the rapid growth of the complexity of a problem as the number of inputs, constraints and bounds increase, making exhaustive exploration infeasible. In formal verification, this combinatorial explosion may occur due to the model describing the hardware logic having a very large number of coverage events to disprove or prove as occurring in the model and the number of states in the model being extremely large. One of the challenges is how to allocate limited compute resources to perform formal verifications of the numerous event instances. Typical formal verification procedures may leave many coverage events unsolved because there were not sufficient resources or time to prove or disprove all coverage events as hit or unhittable.

Described embodiments provide improved computer technology to optimize formal verification of coverage events by determining the priority or order in which the formal verification tool will process the event instances in a current version of the verification model. The priority for performing formal verification of an event instance represented by a node in the event hierarchy tree may be based on hints of whether the event instance in a previous version of the verification model was proved to be hit or unhittable. Further, a decision of hit or unhittable, with respect to one event instance in the event hierarchy tree may be used to set the status of other event instances represented as nodes in the event hierarchy tree as hit or unhittable to further reduce the set of event instances subject to formal verification. Further, a finding of hit or unhittable of an event instance in a current or previous version of the verification model may be used to set a hint for event instances indicating a priority at which the event instances in the event hierarchy tree for the current version of the verification model are subject to formal verification. This propagation of status among nodes and prioritization of nodes to verify conserves computational resources and optimizes formal verification by removing from consideration those nodes that have had their status set through propagation of the status from other nodes. This reduction in the set of nodes that needs to be subject to formal verification allows other nodes to be subject to formal verification that would not otherwise be considered due to time and compute resource constraints.

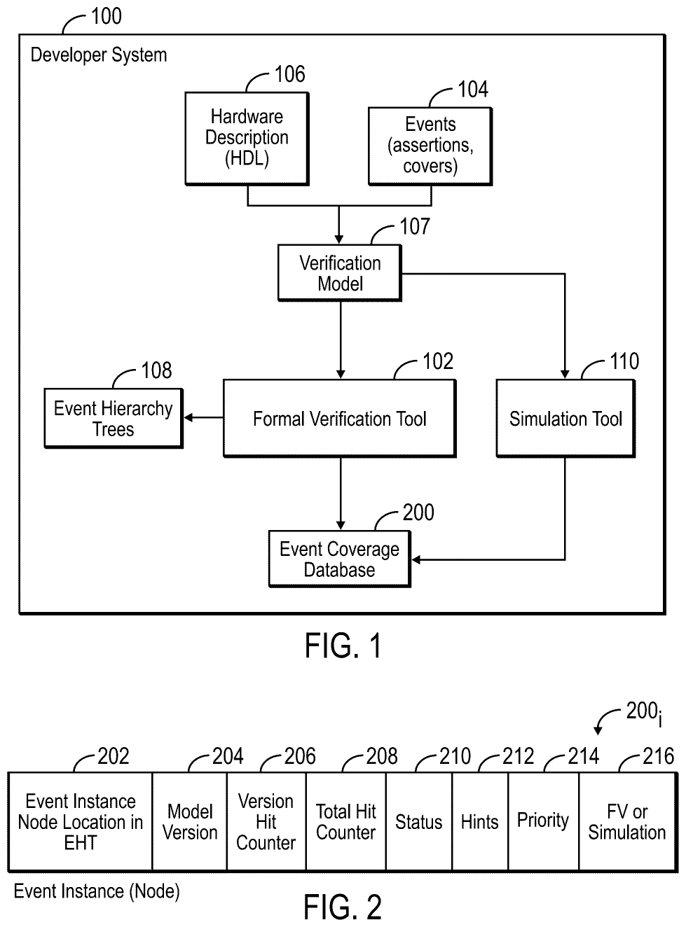

FIG. 1 illustrates an embodiment of a developer system 100 including a formal verification tool 102 to prove or disprove if defined events 104 occur in a hardware description language (HDL) 106, which is a model of hardware logic. The hardware description 106 includes inputs, outputs, state elements and logic that compute next state and outputs from the current state and inputs. The formal verification tool 102 compiles the hardware description 106 into a verification model 107 of the hardware description 106 comprising a mathematical representation of the behavior of the hardware description 106, such as logic and computation paths. The verification model 107 further includes a simulation environment suitable for running simulation tests with the simulation tool 110. In this way, both the formal verification tool 102 and simulation tool 110 can process the verification model 107. The formal verification tool 102 determines where instances of defined events 104 occur in the model 107.

Different design versions of the model, e.g., v1, v2.... vn, represent versions of the logic of the model 107. These different versions are used to build the hardware description model 106, which in turn is used to build the verification model 107, including the simulation model portion for running simulation.

The events 104 may be written with language constructs, such as SystemVerilog Assertions (SVA), that are used to express rules in the design specification. The formal verification tool 102 analyzes the model 107 and determines a cone of influence of all inputs, outputs, internal variables and logic that influence and affect the output event instance using state reduction techniques. The cone of influence for an instance of an event identifies the set of state variable and logic paths in the hardware logic that effect a provided event 104 and that is needed to prove or disprove whether an event instance is hit, unhittable or unsolved. Once the cone of influence is determined for an event instance, the formal verification tool 102 can determine the full state space of possible values the logic within the cone can take, such as by parallelly exploring every path in the state space to determine if the event, e.g., assertion or cover, can be proven correct or wrong.

The events 104 may comprise a user-specified property that is satisfied at a specific time during the course of verification. A Boolean event occurs when a Boolean expression evaluates to true in relation to a specified sample clock. A sequential event is satisfied at the end of a sequence of Boolean events. Once defined, an event can be used in verification as an assertion (a property that is checked), a functional coverage specification (a property that must occur during verification), or a constraint (a property that limits the verification input space). After declaring a property, a verification directive of assert or cover can be used to state how the property is to be used. The verification directives include assert, which specifies that the property is to be used as an assertion (i.e., a property whose failure is reported during verification) or a cover, which specifies that the property is to be used as a functional coverage specification (i.e., a property whose occurrence is reported during verification. The term “event” or “event instance” as used herein refers to any user specified state to check, including an assertion and cover.

The formal verification tool 102 may generate event hierarchy trees 108 for event instances represented as nodes in the trees 108 providing verification information on the event instances, such as proven (hit), not occurring (unhittable) or unsolved.

The developer system 100 may include a simulation tool 110 to determine if events occur using test cases. Information on results of running the simulation tool 110 for nodes in the event hierarchy tree 108 may also be stored in the event coverage database 200.

FIG. 2 illustrates an embodiment of an event instance 200ᵢ in the event coverage database 200 having information on an event instance represented as a node in an event hierarchy tree 108, including: a node location 202 in the event hierarchy tree of the event instance associated with the node 202; a version 204 of the model 107 including the event instance; a version hit counter 206 indicating a number of hits of the event instance during formal verification of the model version 204; a total hit counter 208 indicating total number of hits of the event instance in for the node 202 in the current and previous versions of the model 107; status 210 of the formal verification of the model version 204, such as hit, unhittable or unsolved; hints 212 comprising one or more hints based on the result of performing formal verification for the event instance or other event instances in the event hierarchy tree; a priority 214 determined from the hints 212 indicating a priority at which the event instance 200ᵢ should be subject to formal verification if the status 210 is unsolved; and indication 216 of whether the event instance 200ᵢ has been subject to formal verification from the formal verification tool 102 or simulation from the simulation tool 110.

The arrows shown in FIG. 1 between the components in the developer system 100 represent a data flow among the components.

Generally, program modules, such as the program components 102, 104, 106, 107, 110 may comprise routines, programs, objects, components, logic, data structures, and so on that perform particular tasks or implement particular abstract data types. The program components of the developer system 100 of FIG. 1 may be implemented in one or more computer systems, where if they are implemented in multiple computer systems, then the computer systems may communicate over a network. The program components 102, 102, 104, 106, 107, 110 may be accessed by a processor from memory to execute.

The functions described as performed by the program 102, 104, 106, 107, 110 may be implemented as program code in fewer program modules than shown or implemented as program code throughout a greater number of program modules than shown.

The developer system 100 may comprise one or more computer systems suitable for software development and debugging. The developer system 100 may comprise a physical machine or a virtual machine.

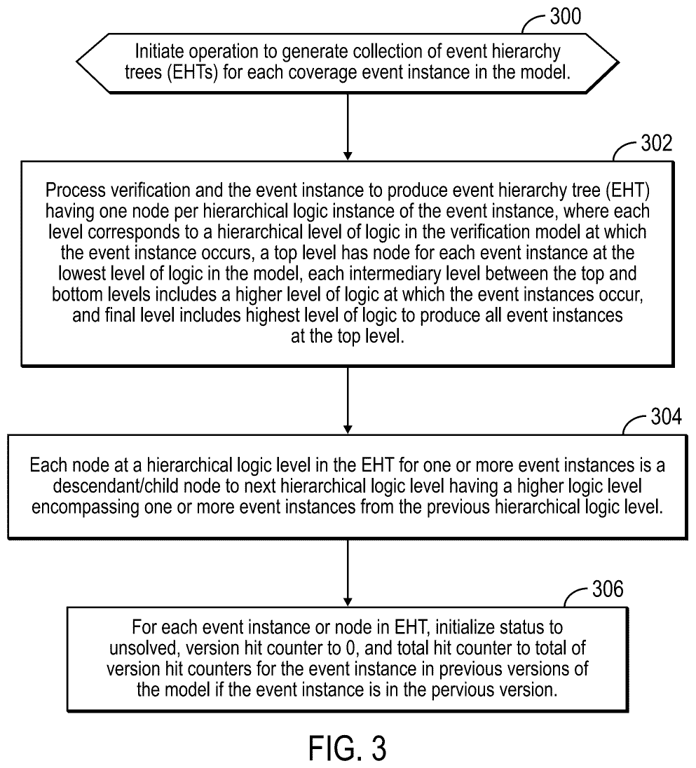

FIG. 3 illustrates an embodiment of operations performed by the formal verification tool 102 to generate event hierarchy trees 108 for a coverage event instance. A collection or forest of event hierarchy trees 108 may be generated for the different coverage events. The operations of FIG. 3 may be performed for each event instance 104 occurring in the model 107. Upon initiating (at block 300) an operation to generate an event hierarchy tree 108 for an event instance occurring at multiple instances in the logic of the verification model 107, the formal verification tool 102 processes (at block 302) the model 107 and the coverage event to produce an event hierarchy tree (EHT) 108 having one node per hierarchical logic instance of the event instance. Each hierarchical level corresponds to a hierarchical level of logic in the software model at which the event instance occurs. A top level has a node for each event instance for the lowest level of logic in the model. Each intermediary level between the top and bottom levels includes a higher level of logic at which the event instances from a previous hierarchical level occur. The bottom level includes a highest level of logic to produce all event instances at the top level. The EHT 108 relationships between levels are established (at block 304) such that each node at a hierarchical logic level in the EHT 108 for one or more event instances is a descendant/child node to next hierarchical logic level having a higher logic level encompassing one or more event instances from the previous hierarchical logic level. For each coverage event instance or node in the EHT 108, the status is initialized (at block 306) to unsolved, the version hit counter 206 for the current logic version subject to the formal verification is initialized to zero, and the total hit counter 208 is set to the total hit counter in the previous version of the node in the previous version of the logic. In the event, there is no previous version of the event instance in the previous version of the model 107, such as if the current model version added the node, then the total hit counter 208 is set to zero.

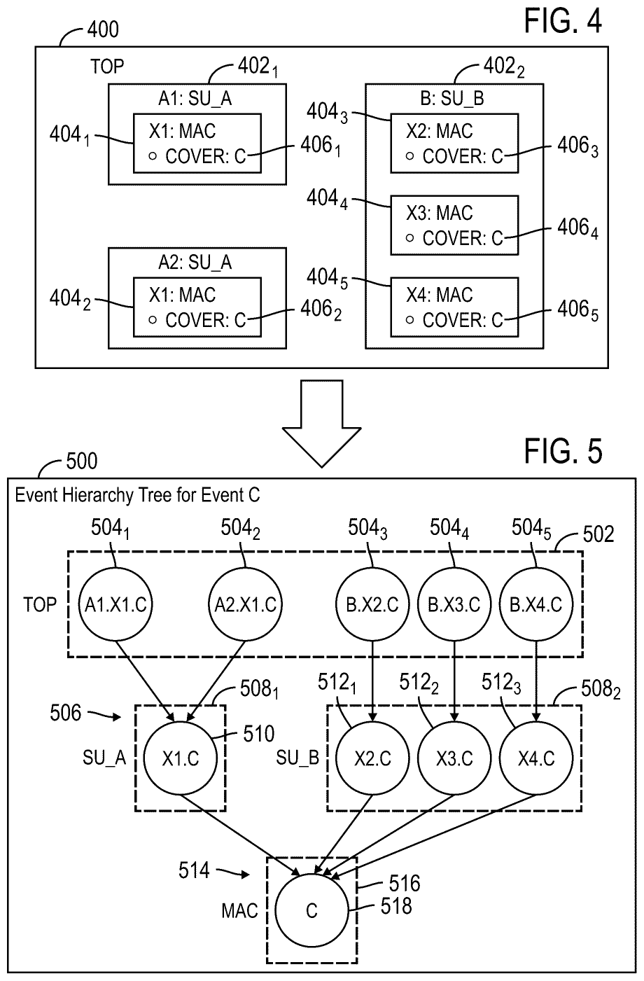

FIG. 4 illustrates an example 400 of the hardware logic having two subunits 402₁, 402₂ of the same sub-unit A of logic and a sub-unit of logic 402₃ representing an instance of sub-unit B of logic. The sub-units of logic 402₁, 402₂, 402₃ have instances of a macro (MAC) 404₁, 404₂, 404₃, 404₄, 404₅ whose execution results in the event instances 406₁, 406₂, 406₃, 406₄, 406₅ of event instance C.

FIG. 5 illustrates an example of an event hierarchy tree 500 for the event instances occurring in the logic 400. The event instances 406₁, 406₂, 406₃, 406₄, 406₅ to prove or disprove as occurring in logic 400 may be represented in the top level 502 as nodes 504₁, 504₂, 504₃, 504₄, 504₅. The second level 506 shows two groupings 508₁, 508₂ of nodes for sub-units A and B of logic, respectively. Grouping 508₁ represents the logic of sub-unit A logic (SU_A) to produce the two event instances of event C 406₁, 406₂ occurring in different instances of the same sub-unit A 402₁, 402₂ and are represented by node 510 to prove or disprove. Grouping 508₂ is associated with the superset of logic, i.e., cone of influence, to produce the event instance of cover C 406₃, 406₄, 406₅ and the logic is subject to formal verification to prove or disprove the event instances 512₁, 512₂, 512₃. The lowest level 514 has one event instance represented by node 516 that is associated with logic for all the occurrences of cover C 406₁, 406₂, 406₃, 406₄, 406₅.

With the above embodiments of the event hierarchy tree, different levels of nodes are associated with different groupings of logic to produce the event instances. The most specific level, lowest logic level, is the top level 502 where the specific cone of influence for one node 504ᵢ associated with one event instance is subject to formal verification to prove or disprove the specific event instance 504ᵢ. The nodes 508ᵢ of the second level 506 are associated with a superset of logic, cone of influence, for all associated event instances 504ᵢ to prove or disprove, to perform formal verification of the event instance at a larger superset of logic. The node 516 at the lowest level 514 is associated with the logic, cone of influence, for all the event instances to prove or disprove the event instances. Further nodes at a higher level, towards the top, are ancestors of nodes at a lower level toward the MAC node 518, whereas nodes at a lower level, such as node 510, are descendants to nodes at a higher level, such as node 504_{1.}

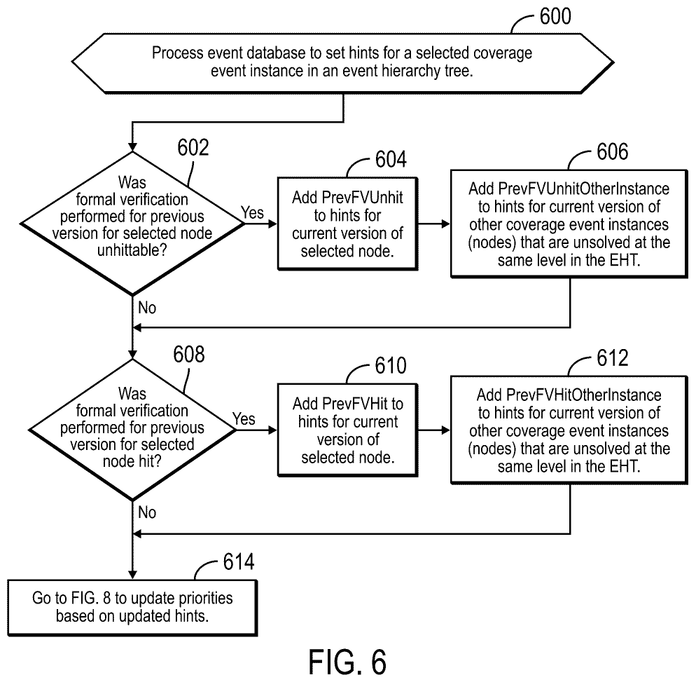

FIG. 6 illustrates an embodiment of operations performed by the formal verification tool 102 to set hints 212 for the event instances/nodes 200ᵢ in the event hierarchy tree 108 by considering the results at nodes 200ᵢ in previous versions of the verification model 107 subject to formal verification. For instance, if a formal verification is going to be performed for version i+1 (vᵢ₊₁) of the model, then hints may be determined from the previous logic version of the model, e.g., version i (vᵢ). The hints 212 may be used to determine the priority 214 for performing formal verification with respect to the nodes in the tree 108. The hints 212 at a node 200ᵢ may include multiple hints if multiple conditions are met with respect to hit/unhittable results in previous versions of the verification model 107. Upon processing (at block 600) the event coverage database 200 to set hints for a selected node in the tree before running formal verification for a current version of the logic, e.g., vᵢ₊₂, if (at block 602) a formal verification performed in a previous version (vᵢ₊₁) for the selected node found the node in the previous version (vᵢ₊₁) unhittable, then “PrevFVUnhit”, indicating previous formal verification of unhittable, is added (at block 604) to the hints 212 for the selected node 202. The hint “PrevFVUnhitOtherInstance” is added (at block 606) to the hints 212 of nodes for other event instances, in the current version (Vᵢ₊₂) in the event hierarchy tree, at a level of the selected node to indicate unhittable was found for another event instance in a previous version of the verification model 107. For instance, with respect to FIG. 5, if node 510 is found unhittable, then the hint “PrevFVUnhitOtherInstance” is added to the hints 212 for nodes 512₁, 512₂, 512₃ in level 506.

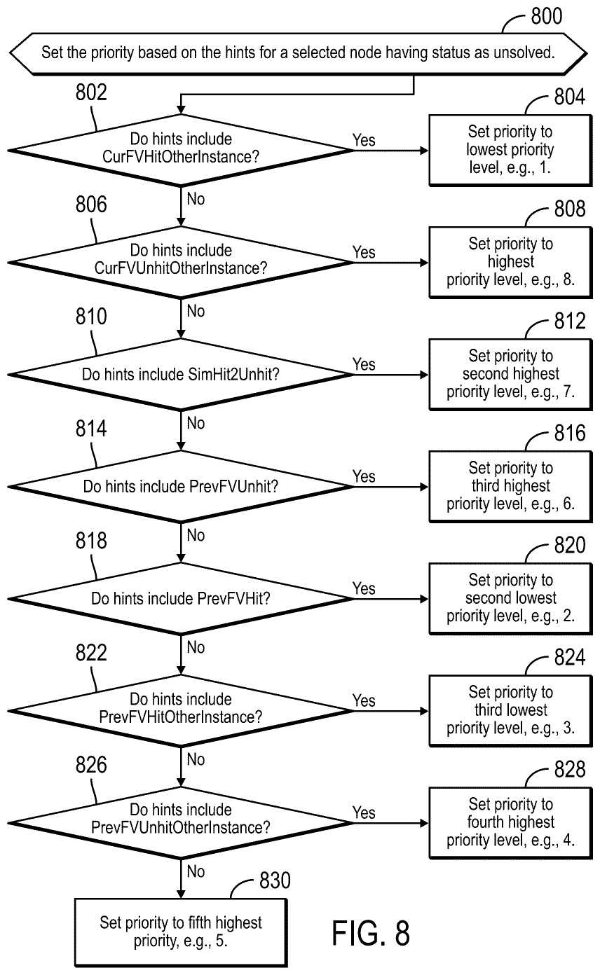

From the NO branch of block 602 or 606, if (at block 608) a formal verification performed for a previous version (vᵢ₊₁) of model 107 found a hit at the selected node, then the hint “PrevFVHit” is added (at block 610) to hints 212 for the current version (vᵢ₊₂) of the selected node 202 of, indicating previous formal verification of hit. The hint “PrevFVHitOtherInstance” is added (at block 612) to the hints 212 of the current version (vᵢ₊₂) of nodes at the hierarchical level of the selected node, indicating a hit in a previous version of the model (vᵢ₊₁) for another event instance. For instance, with respect to FIG. 5, if node 510 is found to have a HIT, then the hint “PrevFVHitOtherInstance” is added to the hints 212 for nodes 512₁, 512₂, 512₃ in level 506. From the NO branch of block 608 or from block 612, control proceeds (at block 614) to FIG. 8 to update the priorities 214 based on the updated hints 212.

With the embodiment of FIG. 6, the event coverage database 200 is processed to determine if formal verifications of nodes in a previous version of the model 107 produced hit or unhittable determinations, or left the event instance unsolved. A hit or unhittable determination of an event instance at a node in a previous version of the model 107 provides hints for determining the priority at which formal verification is performed on event instances in a current version of the model 107. A determination of a hit for an event instance in a previous version of the model 107 indicates other event instances in the same logic unit group or at descendants nodes in the EHT 108 would be found as hit, so running another formal verification for such nodes should have lower priority.

However, an instance of an event previously found to be unhittable does not necessarily indicate related event instances are unhittable, so high priority should be given to performing formal verification of such nodes to confirm the unhittable finding.

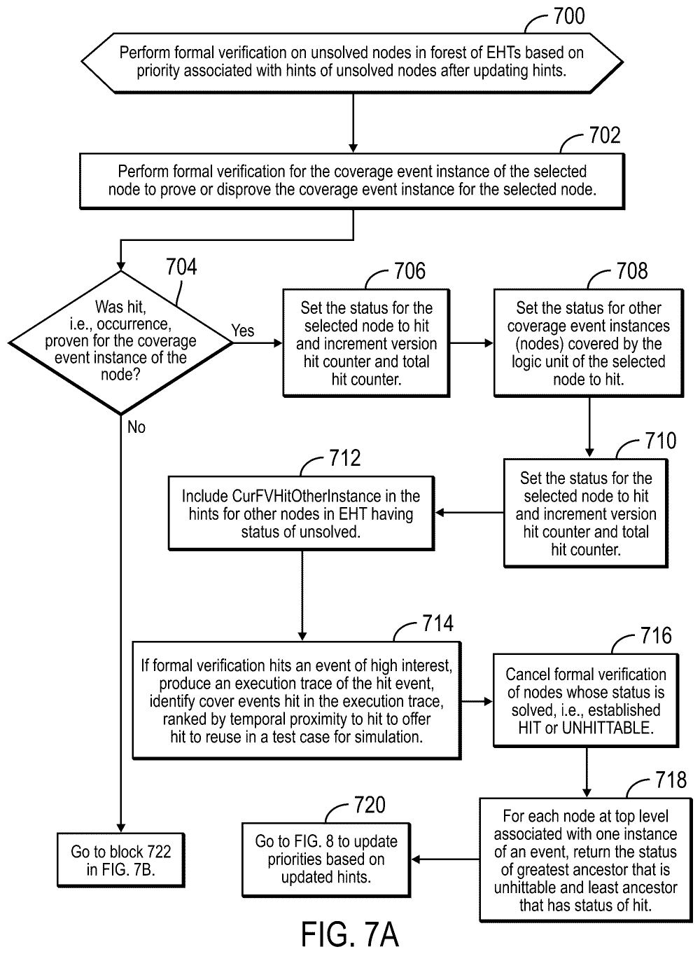

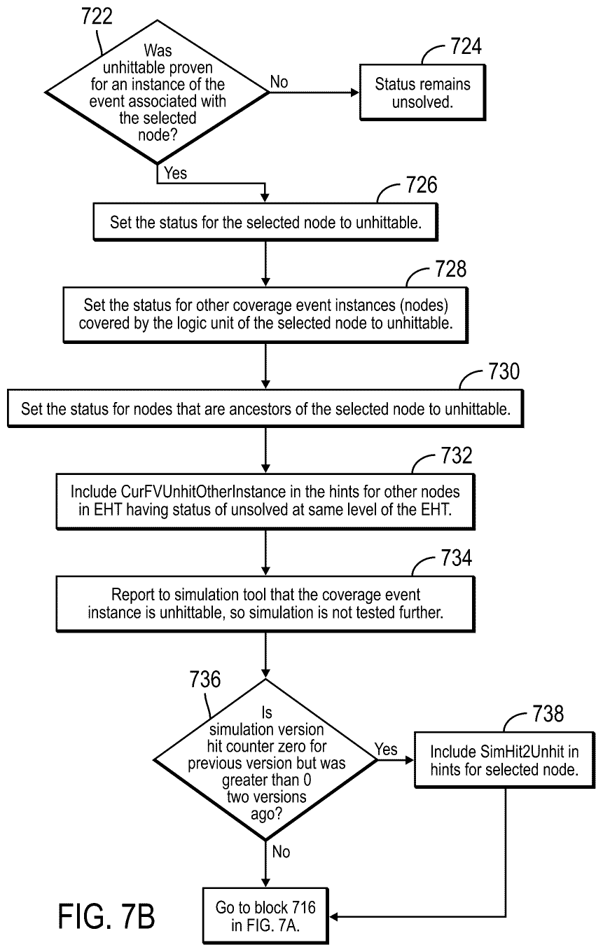

FIGS. 7A and 7B illustrate an embodiment of operations performed by the formal verification tool 102 to perform formal verification to disprove or prove an event instance of a selected node 200ᵢ, where the node is selected for formal verification based on the priority 214 of the node 200ᵢ. Upon selecting (at block 700) a node 200ᵢ to process for the current model version 204 based on the priority 214, one of the highest priority remaining nodes to process, the formal verification tool 102 performs (at block 702) formal verification by a random formal driver driving input through the logic and variables covering the event instances associated with the selected node 202, to prove or disprove an event instance associated with the node 202. If (at block 704) a hit was proven for the event instance/node 200ᵢ, then the status 210 for the selected node 202 is set (at block 706) to indicate a hit, and the version hit counter 206 and total hit counter 208 are incremented. The status 210, for other event instances (nodes) covered by the same logical unit as the selected node are set (at block 708) to indicate a hit. The status 210 for nodes that are descendants in the EHT 108 of the selected node are set (at block 710) to indicate a hit, and the version hit counter 206 and total hit counter 208 are incremented. For example, in FIG. 5, if the status of node 512₁ is set to hit, then the descendent of node 512₁ is node 518, whose status 210 is also set to indicate hit as a descendant. The status of nodes 512₂, 512₃ are also set to indicate a hit because they are covered by the same logic unit 508₂ as node 512₁. The hint of “CurFVHitOtherInstance”, indicating formal verification for the current version of the model, is added (at block 712) to the hints 212 for other instances of the event (nodes) at the hierarchical level of the selected node. For instance, in FIG. 5, if the status of node 512₁ is set to hit, then “CurFVHitOtherInstance” is added to the hints 212 for nodes 510, 512₂, 512₃ at the same level 506.

In certain embodiments, if (at block 714) formal verification determines a hit of an event of high interest, an execution trace of hit event is produced identifying cover events hit in the execution trace, ranked by temporal proximity to the high interest event with the hit, to offer a hit to reuse as a test case for a simulation operation by the simulation tool 110.

If (at block 704) the formal verification did not determine a hit, control proceeds to block 722 in FIG. 7B where if unhittable was not proven for the event associated with the selected node, then the status for the selected event remains (at block 724) as unsolved. If (at block 722) the event represented by the selected node was disproved, e.g., unhittable, then the status 210 for the selected node is set (at block 726) to indicate unhittable. The status 210 for other event instances (nodes) covered by the same logical unit as the selected node are set (at block 728) to indicate unhittable. Further, the status 210 for nodes that are ancestors to the selected node are set (at block 730) to indicate unhittable. For example, in FIG. 5, if the status of node 512₁ is set to unhittable, then the statuses 210 of ancestor nodes 504₁ is set to unhittable as ancestors. The status of nodes 512₂ and 512₃ are set to indicate unhittable because they are covered by the same logic unit 508₂ as the selected nod 512₁. The hint of “CurFVUnhitOtherInstance”, indicating formal verification of the node in the current version is unhittable for another instance of the event, is included (at block 732) in the hints 210 for other nodes at the level of the selected node. For instance, in FIG. 5, if the status of node 512₁ is set to unhittable, then “CurFVUnhitOtherInstance” is added to the hints 212 for nodes 510, 512₂, 512₃ at the same level 506. That the coverage event instance of the selected node is unhittable is reported (at block 734) to the simulation tool so simulation is not tested further for this node.

If (at block 736) the simulation version hit counter 206 was zero for a previous version of the model (vᵢ₊₁), but the simulation version hit counter was greater than zero two versions ago (vᵢ), then the hint of “SimHit2Unhit” is included in the hints 210 for the selected node. “SimHit2Unhit” indicates that the hit counter went from having hits to no hits in previous versions, which hints the node has changed to unhittable. If (at block 736) the simulation version hit counter has not gone from positive to zero, then control proceeds to block 716, et seq. in FIG. 7A.

From block 714 or the NO branch of block 736 or from block 738, formal verification is canceled (at block 716) for nodes in the current version in progress of formal verification whose status has changed from unsolved to hit or unhittable, as the status has now been inferred from the result at one of the other nodes for another instance of the event. For each node 504ᵢ at the top level 502 associated with one instance of an event, the statuses 210 of the greatest ancestor that is unhittable and least ancestor that has status of hit are returned (at bock 718). Control then proceeds (at block 720) to FIG. 8 to update the priorities based on updated hints 212.

With the embodiment of FIGS. 7A and 7B, when an event instance for a node in the event hierarchy tree 108 is determined to be a hit or unhittable, then other nodes at the same level of the tree have their status updated to the determined hit or unhittable. If one instance of the event is determined hit at a level, then other instances of the event at the same level, having similar scope of cones of influence, are also likely to have that same determination. The determination of hit or unhittable may also propagate to descendant and ancestor nodes, respectively. In this way, the status 210 of nodes in an event hierarchy tree 108 may be determined based on formal verification of another node, thus optimizing formal verification by avoiding having to perform formal verification for nodes whose status is changed from unsolved to hit or unhittable based on formal verification of another node in the same event hierarchy tree 108. Reducing the nodes to which formal verification is applied allows compute resources to be redirected to formal verification of nodes and event instances that have not been proven or disproven. Further, providing hints indicating hit or unhittable indicates a priority because nodes with hints indicating hit do not need to be further considered for formal verification because a hit, or the event, has happened. However, nodes having a hint of unhittable, should have higher priority consideration to confirm the event is not later hit and is in fact unhittable.

Further, it is optimal to process events with hints of unhittable as higher priority, because if formal verification can prove an event unhittable, then a conclusion can be made the hint will never be covered by simulation no matter how many tests are run, so that unhittable node maybe be removed from consideration.

FIG. 8 illustrates an embodiment of operations performed by the formal verification tool 102 to update the priority 214 for a selected node whose hints 212 have been updated, including for situations where there are multiple hints provided for a node to select a hint according to a hierarchy of hints to determine priority. Upon initiating (at block 800) an operation to update the priority 214 based on the hints 212 indicated for a selected node, if (at block 802) the hint includes “CurFVHitOtherInstance”, indicating another node at the same level of the selected node in the event hierarchy tree 108 was proven to have a hit during a current formal verification run, then the priority 214 is set to a lowest priority level, e.g., 1. If (at block 802) the hints 212 do not include “CurFVHitOtherInstance”, then if (at block 806) the hints 212 include “CurFVUnhitOtherInstance”, indicating another node at the same level of the selected node in the event hierarchy tree 108 was proven to be unhittable during a current formal verification run, then the priority 214 is set (at block 808) to a highest priority level, e.g., 8. If (at block 806) the hints 212 do not include “CurFVUnhitOtherInstance”, then if (at block 810) the hints 212 include “SimHit2Unhit”, indicating the selected node was determined to have a hit during a simulation test performed by the simulation tool 110 and now was found to be unhittable through the current formal verification, then the priority 214 is set (at block 812) to a second highest priority level, e.g., 7. If (at block 810) the hints 212 do not include “SimHit2Unhit”, then if (at block 814) the hints 212 include “PrevFVUnhit”, indicating the selected node was proven to be unhittable during a previous formal verification, such as for a previous version of the selected model, then the priority 214 is set (at block 816) to a third highest priority level, e.g., 6. If (at block 818) the hints 212 do not include “PrevFVHit”, then if (at block 822) the hints 212 include “PrevFVHitOtherInstance”, indicating another node at the same level as the selected node was proven to be a hit during a previous formal verification, such as for a previous version of the selected model, then the priority 214 is set (at block 824) to a third lowest priority level, e.g., 3. If (at block 826) the hints 212 do not include “PrevFVHitOtherInstance”, then if (at block 822) the hints 212 include “PrevFVUnhitOtherInstance”, indicating another node at the same level as the selected node was proven to be unhittable during a previous formal verification, such as for a previous version of the selected model, then the priority 214 is set (at block 828) to a fourth highest priority level, e.g., 4. If (at block 826) the hints 212 do not include “PrevFVUnhitOtherInstance”, then there are no hints 212, and the priority is set (at block 830) to the fifth highest priority, e.g., 5.

The embodiment of operations of FIG. 8 provide a hierarchy of how hints may control the determination of the priority or order of nodes on which formal verification is performed, such that if there are multiple hints 212 for a node, only one of the hints, the highest in the hierarchy, is used to determine the priority 214 at which nodes are subject to formal verification.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

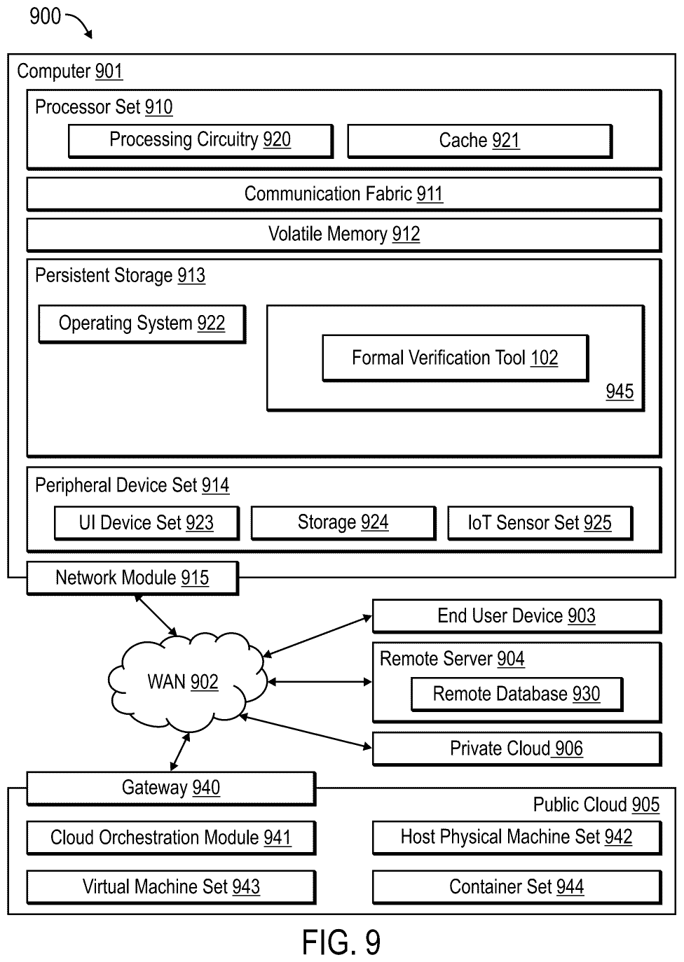

With respect to FIG. 9, computing environment 900 contains an example of an environment for the execution of at least some of the computer code involved in performing the inventive methods, including the formal verification tool 102 of FIG. 1 in block 945 to generate an event hierarchy trees 108 for instances of events and perform formal verifications on the nodes of the event hierarchy trees 108. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer-readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer-readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

CLOUD COMPUTING SERVICES AND/OR MICROSERVICES (not separately shown in FIG. 9): private and public clouds 906 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for performing formal verification of a plurality of event instances within a verification model, comprising:
deriving priorities for event instances that are subject to formal verification using formal verification results obtained from a current version of the verification model and from formal verification results obtained from a previous version of the verification model;
performing formal verification of event instances in an order based on the derived priorities for the event instances; and
performing formal verification for a first set of event instances having a first priority before formal verification is performed for a second set of event instances having a second priority that is lower than the first priority.

2. The computer implemented method of claim 1, further comprising:
indicating the first priority for event instances that were not hit during the formal verification of the current version of the verification model and for event-instances not hit during simulation in the previous version of the verification model; and
indicating the second priority for event instances that were not hit during simulation of the current version of the verification model and for event instances that were hit at least once in the previous version of the verification model.

3. The computer implemented method of claim 1, further comprising:
indicating the first priority for a first event instance in response to a second event instance not hit during a simulation of the first event instance in one of the current version of the verification model and the previous version of the verification model; and
indicating the second priority for the first event instance in response to the second event instance hit at least once in one of the current version of the verification model and the previous version of the verification model.

4. The computer implemented method of claim 1, further comprising:
indicating the first priority for a first set of event instances that are proven unhittable on a formal verification of the previous version of the verification model; and
indicating the second priority for a second set of event instances found hit by formal verification on the previous version of the verification model.

5. The computer implemented method of claim 1, further comprising:
indicating the first priority for a first event instance based upon formal verification analysis in the current version of the verification model finding that a second event instance is unhittable; and
indicating the second priority for the first event instance based upon formal verification analysis in the current version of the verification model finding that the second event instance is hit.

6. The computer implemented method of claim 1, further comprising:
indicating the first priority for a first event instance based upon formal verification analysis in the previous version of the verification model finding that a second event instance is unhittable; and
indicating the second priority for the first event instance based upon formal verification of the current version of the verification model finding that the second event instance is hit.

7. A computer implemented method for performing formal verification of a plurality of event instances within a verification model, comprising:
providing an event hierarchy tree constructed to associate a relationship between event instances derived from design entities declared in the verification model;
providing an intermediary level of the event hierarchy tree that groups at least one node that shares a subunit of logic, and a bottom level of the event hierarchy tree that includes one node for all the event instances;
maintaining for each node of a plurality of nodes in the event hierarchy tree:
a hit status of an event instance associated with the node determined from formal verification of a current version of the verification model; and
a prioritization based on the hit status of the event instance associated with the node in one of the current version and a previous version of the verification model; and
using the prioritization of the plurality of nodes in the event hierarchy tree to determine an order in which formal verification is performed on the event instances represented by the plurality of nodes in the event hierarchy tree.

8. The computer implemented method of claim 7, further comprising:
running formal verification of event instances for nodes at various hierarchical levels in the event hierarchy tree.

9. The computer implemented method of claim 7, further comprising:
in response to proving through formal verification that an event instance associated with a selected node at a specified hierarchical level of the event hierarchy tree is hit, indicating statuses of descendant nodes in the event hierarchy tree of the selected node as hit; and
in response to proving through formal verification that the event instance associated with the selected node is unhittable, indicating statuses of ancestor nodes in the event hierarchy tree of the selected node at which the hit was detected as unhittable.

10. The computer implemented method of claim 7, further comprising:
indicating a hint for a selected node at a specified level of the event hierarchy tree, wherein the hint is selected from the group consisting of:
a first hint in response to formal verification of the current version of the verification model proving another instance of the event instance for another node at the specified level as unhittable;
a second hint in response to the hit status of for the selected node in a simulation of the previous version of the verification model changing from hit to not hit;
a third hint in response to the formal verification of the previous version of the verification model proving the event instance of the selected node as unhittable;
a fourth hint in response to the formal verification of the previous version of the verification model proving another event instance for another node at the specified level as unhittable;
a fifth hint in response to the formal verification of the previous version of the verification model providing another event instance for another node at the specified level as hit;
a sixth hint in response to the formal verification of the previous version of the verification model proving the event instance for the selected node as hit; and
a seventh hint in response to the formal verification of the current version of the verification model proving another instance of another node at the specified level as hit,
wherein the first, second, third, fourth, fifth, sixth and seventh hints are associated with descending priority values from the first hint to the seventh hint indicating an order in which the formal verification should be performed with respect to the selected node.

11. A computer program product for performing formal verification of a plurality of event instances within a verification model, the computer program product comprising a computer readable storage medium having computer readable program code embodied therein that is executable to perform operations, the operations comprising:
deriving priorities for event instances that are subject to formal verification using formal verification results obtained from a current version of the verification model and from formal verification results obtained from a previous version of the verification model;
performing formal verification of event instances in an order based on the derived priorities for the event instances; and
performing formal verification for a first set of event instances having a first priority before formal verification is performed for a second set of event instances having a second priority that is lower than the first priority.

12. The computer program product of claim 11, wherein the operations further comprise:
indicating the first priority for event instances that were not hit during the formal verification of the current version of the verification model and for event-instances not hit during simulation in the previous version of the verification model; and
indicating the second priority for event instances that were not hit during simulation of the current version of the verification model and for event instances that were hit at least once in the previous version of the verification model.

13. The computer program product of claim 11, wherein the operations further comprise:
indicating the first priority for a first event instance in response to a second event instance not hit during a simulation of the first event instance in one of the current version of the verification model and the previous version of the verification model; and
indicating the second priority for the first event instance in response to the second event instance hit at least once in one of the current version of the verification model and the previous version of the verification model.

14. The computer program product of claim 11, wherein the operations further comprise:
indicating the first priority for a first set of event instances that are proven unhittable on a formal verification of the previous version of the verification model; and
indicating the second priority for a second set of event instances found hit by formal verification on the previous version of the verification model.

15. The computer program product of claim 11, wherein the operations further comprises:
indicating the first priority for a first event instance based upon formal verification analysis in the current version of the verification model finding that a second event instance is unhittable; and
indicating the second priority for the first event instance based upon formal verification analysis in the current version of the verification model finding that the second event instance is hit.

16. The computer program product of claim 11, wherein the operations further comprise:
indicating the first priority for a first event instance based upon formal verification analysis in the previous version of the verification model finding that a second event instance is unhittable; and
indicating the second priority for the first event instance based upon formal verification of the current version of the verification model finding that the second event instance is hit.

17. A computer program product for performing formal verification of a plurality of event instances within a verification model, the computer program product comprising a computer readable storage medium having computer readable program code embodied therein that is executable to perform operations, the operations comprising:
providing an event hierarchy tree constructed to associate a relationship between event instances derived from design entities declared in the verification model;
providing an intermediary level of the event hierarchy tree that groups at least one node that shares a subunit of logic, and a bottom level of the event hierarchy tree that includes one node for all the event instances;
maintaining for each node of a plurality of nodes in the event hierarchy tree:
a hit status of an event instance associated with the node determined from formal verification of a current version of the verification model; and
a prioritization based on the hit status of the event instance associated with the node in one of the current version and a previous version of the verification model; and
using the prioritization of the plurality of nodes in the event hierarchy tree to determine an order in which formal verification is performed on the event instances represented by the plurality of nodes in the event hierarchy tree.

18. The computer program product of claim 17, wherein the operations further comprise:
running formal verification of event instances for nodes at various hierarchical levels in the event hierarchy tree.

19. The computer program product of claim 17, wherein the operations further comprise:
in response to proving through formal verification that an event instance associated with a selected node at a specified hierarchical level of the event hierarchy tree is hit, indicating statuses of descendant nodes in the event hierarchy tree of the selected node as hit; and
in response to proving through formal verification that the event instance associated with the selected node is unhittable, indicating statuses of ancestor nodes in the event hierarchy tree of the selected node at which the hit was detected as unhittable.

20. A system for performing formal verification of a plurality of event instances within a verification model, comprising:
a processor; and
a computer readable storage medium having computer readable program code embodied therein that when executed by the processor performs operations, the operations comprising:
deriving priorities for event instances that are subject to formal verification using formal verification results obtained from a current version of the verification model and from formal verification results obtained from a previous version of the verification model;
performing formal verification of event instances in an order based on the derived priorities for the event instances; and
performing formal verification for a first set of event instances having a first priority before formal verification is performed for a second set of event instances having a second priority that is lower than the first priority.

21. The system of claim 20, wherein the operations further comprise:
indicating the first priority for event instances that were not hit during the formal verification of the current version of the verification model and for event-instances not hit during simulation in the previous version of the verification model; and
indicating the second priority for event instances that were not hit during simulation of the current version of the verification model and for event instances that were hit at least once in the previous version of the verification model.

22. The system of claim 20, wherein the operations further comprise:
indicating the first priority for a first event instance in response to a second event instance not hit during a simulation of the first event instance in one of the current version of the verification model and the previous version of the verification model; and
indicating the second priority for the first event instance in response to the second event instance hit at least once in one of the current version of the verification model and the previous version of the verification model.

23. The system of claim 20, wherein the operations further comprise:
indicating the first priority for a first set of event instances that are proven unhittable on a formal verification of the previous version of the verification model; and
indicating the second priority for a second set of event instances found hit by formal verification on the previous version of the verification model.

24. The system of claim 20, wherein the operations further comprise:
indicating the first priority for a first event instance based upon formal verification analysis in the current version of the verification model finding that a second event instance is unhittable; and
indicating the second priority for the first event instance based upon formal verification analysis in the current version of the verification model finding that the second event instance is hit.

25. The system of claim 20, wherein the operations further comprise:
indicating the first priority for a first event instance based upon formal verification analysis in the previous version of the verification model finding that a second event instance is unhittable; and
indicating the second priority for the first event instance based upon formal verification of the current version of the verification model finding that the second event instance is hit.
